(19) United States
(12) Patent Application Publication
(10) Pub. No.: US 2006/0143147 A1
(43) Pub. Date: Jun. 29, 2006

(54) Systems and methods for client-side cached representation of database-persisted information

(76) Inventors: Joseph A. Pearson, Kennesaw, GA (US); Tihomir Surdilovic, Smyrna, GA (US); Jon Badenell, Marietta, GA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 11/023,768

(22) Filed: Dec. 28, 2004

(51) Int. Cl. G06F 17/30

(52) U.S. Cl. 707/1

(57) ABSTRACT

Temporary client-side caching of server-side persisted database information is disclosed. The server sends the persisted information to the client, where it is stored in temporary cache memory, such as in a temporary cookie. Subsequent requests from the client to the server include the information in the temporary memory, thereby precluding the desirability of the server accessing a server-side database to obtain the information. Additionally, the information sent to the client initially may be associated with only current client requests, as opposed to sending all information located on the database to the client, maximizing infrastructure and resources and conserving bandwidth.

### FIELD OF THE INVENTION

The present invention relates in general to the field of computer science. More particularly, the present invention relates to systems and methods for storing information associated with a client for use by the client and a server. BACKGROUND OF THE INVENTION

Information describing a client may be stored by a web server for further reference and client-specific tailoring of web services. The information, that is, settings may be stored, for example, as a record or some other server-side object on a web server database and a user identification may be set in a cookie keyed to the record at the client. This method, however, may create web server costs in terms of hardware, performance, and speed of execution. For example, web page requests from a client to a web server may include cookies valid for the web server resource being requested. The web server may respond by accessing a database and sending the same cookies back to the client. As web servers receive more and more page views, their capacity typically must be increased accordingly. More and larger web servers may be required to match the increased capacity needs merely to access a database, retrieve cookies that the client already has, and send the cookies to the client.

An alternative method of storing settings specified by the client may be to store the settings in permanent cookies on the client machine. This method may not be optimal, as the client's browser may impose limits on the amount of information that may be stored in a cookie file. For example, some browsers limit cookie storage to a maximum of 4K bytes or 20 cookies for each top-level domain name. Additionally, the cookies may be specific to the browser on the machine, and therefore, changes to web server settings regarding a user made on one computer may not be reflected when the web server is accessed by the user from another computer. The method may also require a large bandwidth overhead, as the client passes a large volume of information in every request to the web server.

Therefore, there is a need for web servers to access stored setting information describing users while minimizing server-side infrastructure costs and avoiding problems associated with client-side persisted cookie storage.

### SUMMARY OF THE INVENTION

The present invention is directed to systems and methods for providing client-side cached representation of user information persisted on a server-side database. The invention enables a web server to access previously stored information, such as user settings or preferences, on a web server database and to send and temporarily store the settings in cache memory on a client. The client then may send this cached information when requesting web server pages, products, services, etc., associated with the cached information. In this way, the web server may satisfy a client request using client-provided information without accessing the web server database. Additionally, the cache memory may be in the form of temporary cookies that are deleted when a web browser at the client is closed, thereby ensuring that the web server's persisted information is the most current and is available to the user regardless of the client used to access the web server. Deleting the cache memory also may facility web server capacity conservation by preventing the client from sending cookies during the initial contact with the web server.

In a related aspect of embodiments of the invention, instead of sending all persisted information to the client when the client accesses the web server, only information pertinent to the services, products, pages, etc., requested by the client may be sent to the client. In this way, if a web server offers, for example, five products, and during a visit, the user only accesses one of the five products, only the persisted information regarding the one product may be sent to the user. This approach may also minimize database accessing and infrastructure costs and help maximize web server capacity.

The foregoing and other aspects of the present invention will become apparent from the following detailed description of the invention when considered in conjunction with the accompanying drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is an overview of an environment in which the present invention may operate;

FIGS. 2A and 2B depict a block diagram of an example method for client-side cached representation of server-side persisted information, according to the invention;

FIG. 3 depicts a flow diagram of an example method for client-side cached representation of server-side persisted information, according to the invention; and

FIG. 4 depicts a flow diagram of an alternative example method for client-side caching of server-side persisted information, according to the invention.

### DETAILED DESCRIPTION OF ILLUSTRATIVE EMBODIMENTS

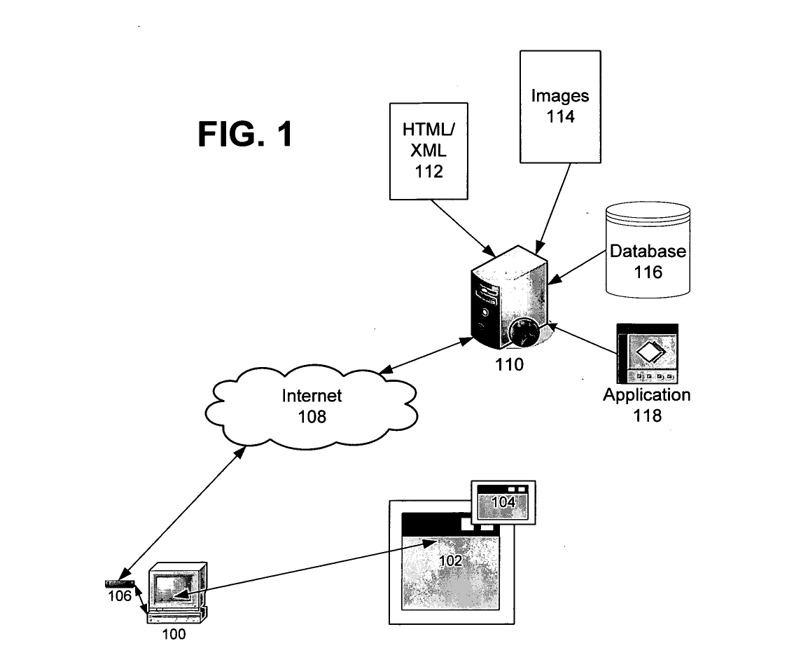

FIG. 1 illustrates an overview of an environment in which embodiments of the present invention may operate. A personal computer or client 100 may run a web browser 102 to fetch and display web pages. Web pages may include HTML pages, XML pages, or similar web pages. In this example implementation, the web browser 102 may be any web browser such as Internet Explorer, Netscape Navigator, Mozilla Firefox, etc. The web browser 102 fetches HTML, XML, or other similar web pages from a web server 110 via a modem 106 (e.g., cable modem, DSL modem, or conventional modem) connected to the Internet 108. The web server 110 serves, e.g., HTML/XML pages 112 and images 114. Other media, such as flash media, video, audio, etc., may be played by a player 104 that is embedded in the web page as displayed in the browser 102 or a separate application.

When a user connects to the web server 110, the browser 102 points to a specified URL of the HTML/XML page 112 to be retrieved. A TCP/IP connection is established with the web server 110 and a request is issued for the page stored at the specified URL by issuing an HTTP request to the server 110. In addition to HTML/XML code, this page may incorporate other information content, such as images 114, audio, video, executable programs, products, services, etc. The page 112 and images 114 may be stored as files in a file system of the web server 110. The page 112 may incorporate the images 114 using HTML/XML tags that specify the location of files or other Internet resources containing the images on the Internet 108.

The web server 110 may also include an application 118. The application 118 may be a product, resource, etc., offered by the web server 110 to the client 100. A database 116 may be associated with the web server 110 and with the application 118. The database 116 may have stored thereon information regarding clients such as the client 100 that visit the web server 110 or access the application 118. For example, such information may include preferences, financial information (e.g., credit card information), address, particular interests, etc., of the client 100.

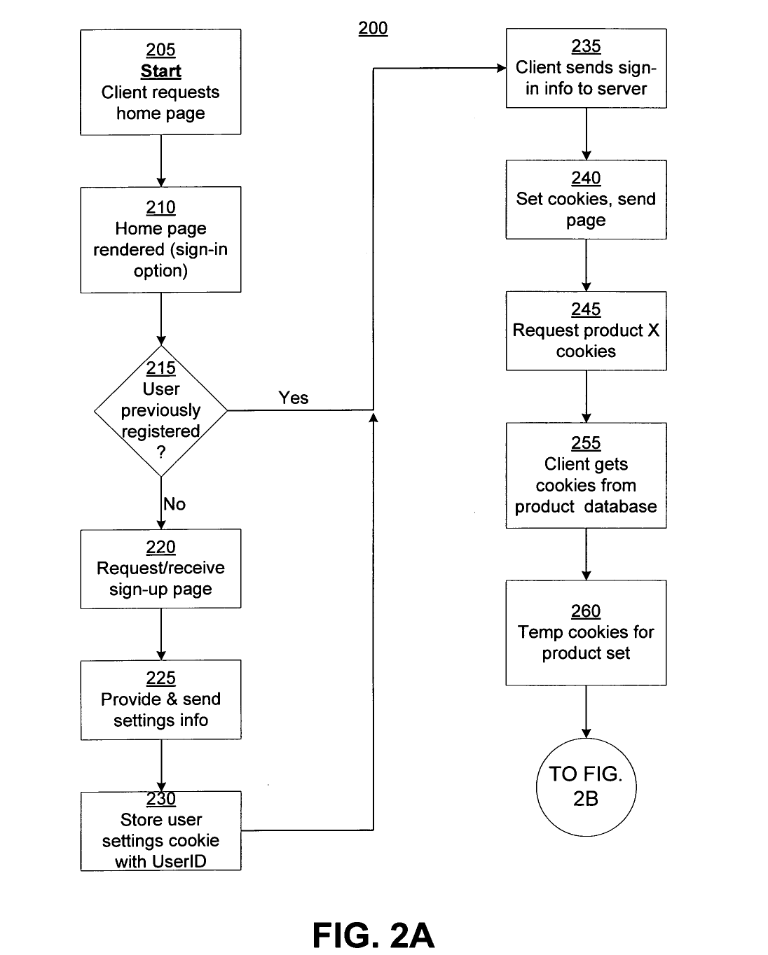

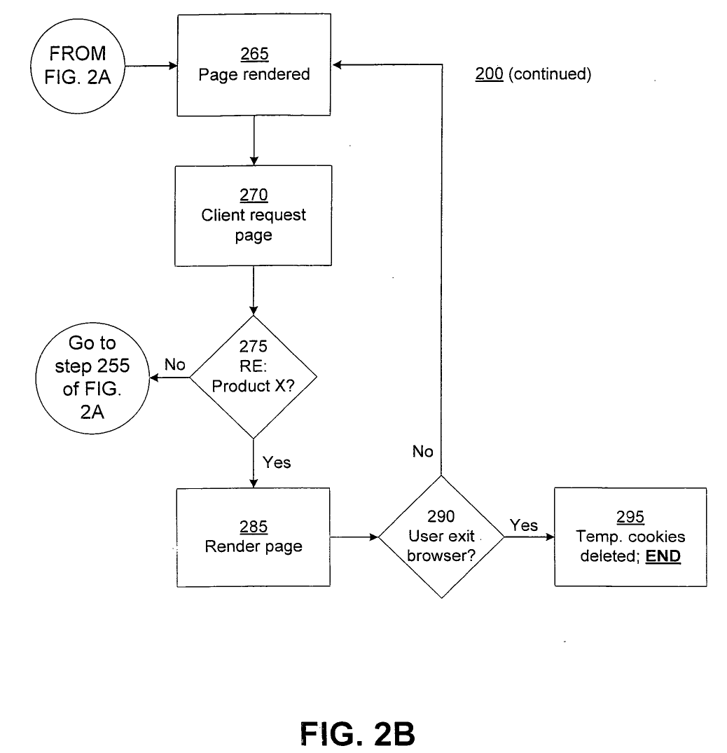

FIGS. 2A and 2B depict a block diagram of an example method 200 for client-side cached representation of server-side persisted information, according to the invention. The method 200 may start at step 205 with the client 100 requesting a page such as a home page or a start page from the web server 110. At step 210 the page requested at step 205 may be rendered. Such a page may provide a mechanism for the user of the client 100 to provide identifying information to the web server 110. For purposes of explaining the example method 200, the web server 110 requires the user to provide predefined information such as a user name and password. Alternatively, the web server 110 may, for example, obtain information stored in a permanent cookie on the client 100 that may include a user identification (UserID) of the user.

If, at step 215, the user has not previously registered with the web server 110 (e.g., does not have a user name and password), then the user, through the client 100, may request to become registered and may receive a page for providing registration information at step 220. The user may fill in the information requested and at step 225, send a page to the web server 110 containing the requested information. At step 230, the web server 110 may store the information in the web server database 116 as the settings or preferences associated with the user. The settings or preferences information may be associated with a UserID for future reference.

At step 235, the client 100 may provide the predetermined sign-in information. The web server 110 may, at step 240, set a cookie with the settings or preferences associated with the UserID of the user of the client 100 and send a page to the client 100. Such a page may include, for example, standard products or services offered by the web server 110 to all registered users. The web server 110 may also show certain products or services not available generally to all registered users but for which the user of the client 100 is registered. While the web server 110 may show this information to the client 100, it may refrain from sending all cookies related to the products or services for which the user is registered. For example, the user may be registered to use a product X but may not have selected the product X during the current visit to the web server 110. Therefore, the web server 110 may refrain from sending the client 100 cookies related specifically to the product X. In this way, the web server 110 may be returning a web page without sending all cookies regarding the user to the client 100, conserving resources and bandwidth at both the web server 110 and client 100.

A cookie is a set of data that the web server 110 and the client 100 may exchange. The data may be virtually any type of information, but typically cookies are used to authenticate or identify a user of a web server and enable web server personalization such that different web pages on the web server may be presented to different users depending on interests, for example, demonstrated by the users during previous visits. The web server 110 and the web browser 102 may save the data the cookie contains about the user. Cookies may be “temporary” or “permanent.” Temporary cookies are cookies that may be retained on the client 100 while the client's web browser 102 is operating and may be automatically deleted when the web browser 102 is closed. Permanent cookies generally remain on the client 100 when the web browser 102 is operating or closed, and can be deleted when predefined events occur or manually by the user of the client 100.

At step 245, the client 100 may request the product X, and the web server 110 may send cookies related to product X to the client 100 at step 255. These cookies may be temporary cookies stored in a temporary cookie file on the client 100 at step 260. The product X may then be rendered on the client 100 at step 265.

At step 270, the client 100 may request a page or other information regarding the product X. Because the client 100 has the temporary cookies for the product X, the web server may send the requested page or information for rendering at step 285 without implicating the database 116. Of course, if the client 100 makes a request regarding a different product for which the client 100 has not received specific temporary cookies, then the process described herein regarding the product X starting at step 255 may be repeated for the other product.

The process for obtaining more information or pages from the product X may continue without implicating the database 116 for the life of the product X temporary cookies. If, at step 290, however, the browser 102 is closed, the temporary cookies may be deleted from the client 100 and further use of the product X may require repeating steps herein described. By allowing the product X cookies to be deleted from the client 100, infrastructure and bandwidth may be maximized by avoiding sending the product X cookies back and forth even when the client 100 may not be interested in the product X during a subsequent visit. If the cookies for the product X were permanent rather than temporary, then when the client 100 subsequently accesses the web server 110, the client 100 may needlessly send the permanent cookies to the web server 110 and the web server 110 may spend time looking at the cookies and sending the same cookies back to the client 100. This may occur even if the client 100 does not request the product X.

Also in this way, if the user of the client 100 accesses the web server 110 from a second client (e.g., a computer different from the client 100), any changes to the settings or preferences associated with the UserID of the client 100 made from the different machine may be reflected when the client 100 subsequently accesses the web server 110 at the client 100. That is, the new settings will be saved at the server 110 and not at the second client.

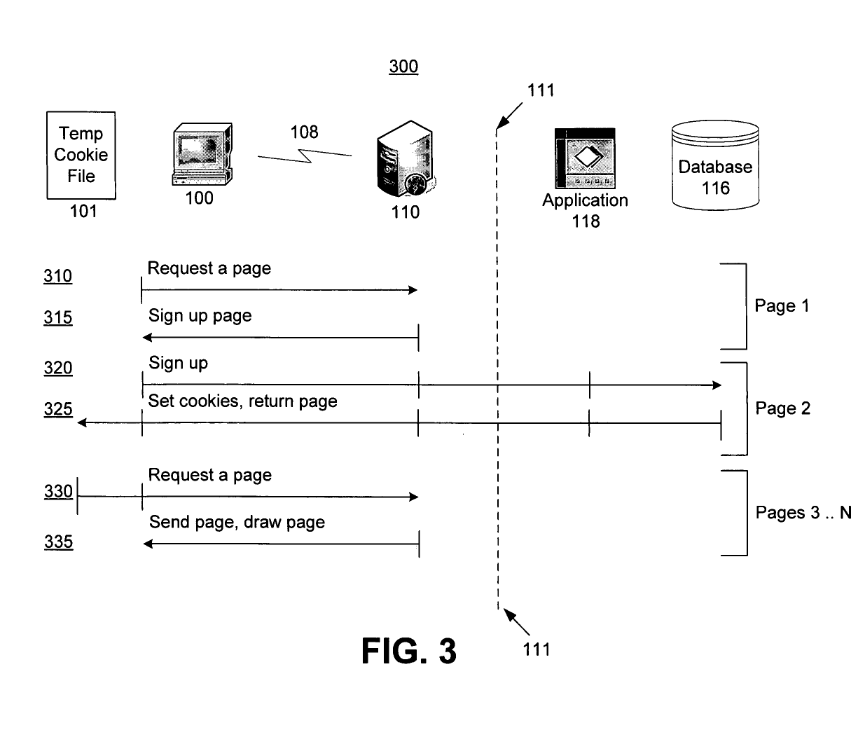

FIG. 3 depicts a flow diagram of an example method 300 for client-side cached representation of server-side persisted information, in accordance with the invention. The method 300 may start at step 310 with the client 100 requesting a page such as a home page or a start page from the web server 110. At step 315, the web server 110 may send a first page such as a sign-up page to the client 100 on which the user of the client 100 may provide predefined information such as a user name and password. Such a page may provide a mechanism for the client 100 to identify it to the web server 110. For purposes of explaining the example method 300, the web server 110 requires the client 100 to provide the predefined information. Alternatively, the web server 110 may obtain information stored in a permanent cookie on the client 100 that may include a user identification (UserID) of the client 100.

At step 320, the client 100 may send the registration information to the web server 110. The web server 110 may use this information to link a predefined UserID with the registration information and access the database 116 for temporary cookies containing setting or preference information associated with the UserID.

At step 325, the web server may return a second page to the client 100 that may provide, for example, a listing of the services, products, etc. offered by the web server 110. Additionally, the web server 110 may send temporary cookies to the client 100 containing the settings or preferences for the client 100. The temporary cookies may be stored on the client 100 in a temporary cookie file 101. The temporary cookies may be used in rendering the requested page and subsequent related pages without necessitating the server to perform subsequent database calls.

At step 330, the client may make a subsequent request for a page from the web server 110. The request may be accompanied by the temporary cookies from the temporary cookie file 101, and therefore, the web server 110 may satisfy the request and provide a third page at step 335 without accessing the database 116. In this way, according to an embodiment of the invention, certain communications between the client 100 and the web server 110 may be completed without requiring the web server 110 to access the application 118 or the database 116. That is, communications between the client 100 and the web server 110 may remain on the left-hand side of the vertical dotted line 111, without requiring the application 118 or the application database 116 on the right-hand side of the line 111 to send or receive cookies. This may result in a decrease in the number of database machines needed while providing scalability and optimized performance.

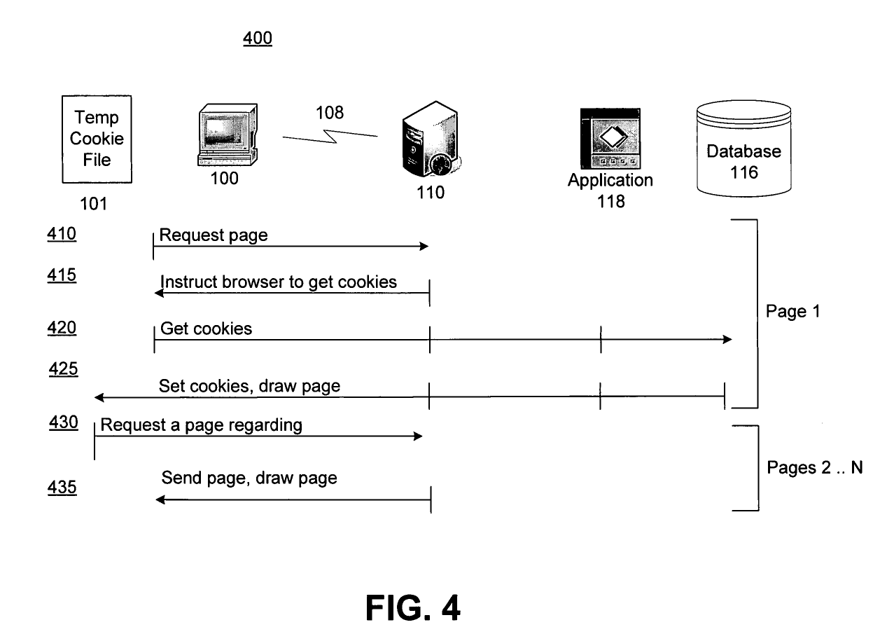

FIG. 4 depicts a flow diagram of an alternative example method 400 for client-side caching of server-side persisted information according to the invention. The web server 110 may require the client 100 to initially register with the web server 110 prior to accessing certain services, products, etc. Example methods for such initial registration are explained herein, particularly with regard to steps 310-325 in FIG. 3. Additionally the web server depicted in FIG. 4 may require the client 100 to register for particular products or services in addition to initially registering for the web server 110 generally. Such products or services, for example, may require additional information or fees from the client 100.

At step 410 the registered user of the client 100 may request the product X from the web server 110. At step 415, the web server 110 may instruct the web browser 102 to get cookies for the product X. The client 100 may request pertinent cookies related to the product from the database 116. The request may be in the form of a program written in, for example, JavaScript.

The web server 110, at step 420, may send to the client 100 a first page with the product X. Additionally, the web server 110 may send temporary cookies for the product X including settings or preferences pertinent to the UserID for the client 100. Alternatively, at step 420, the web server 110 may send temporary cookies containing the settings or preferences of the client 100 with regard to all products offered by the web server 110 for which the client 100 is registered (i.e., including those products that the client 100 is not currently requesting). The temporary cookies may be stored in a temporary cookie file 101 on the client 100.

At step 430, the client may make a request for a page from the web server 110 relating to the product X. The request may include the temporary cookies obtained at step 425. Because the web server 110 may have access, from the temporary cookies, to the settings or preferences specific to the client 100 with regard to the product X, the web server desirably will send, at step 435, the requested product or web page without accessing the database 116 and without sending cookies comprising the settings back to the client 100.

Although illustrated and described herein with reference to certain specific embodiments, the present invention is nevertheless not intended to be limited to the details shown. Rather, various modifications may be made in the details within the scope and range of equivalents of the claims and without departing from the invention.

What is claimed:

1. A method, comprising:
storing a group of settings associated with a user of a client on a database of a server, wherein the user is authorized to view a plurality of pages provided by the server;
receiving a first request from the client for a first page from the plurality of pages;
accessing the database to retrieve a first subgroup of settings from the group of settings, wherein the first subgroup of settings is associated with the first page and is smaller than the group of settings; and
sending the first subgroup of settings to the client.

2. The method of claim 1, further comprising:
sending the first page to the client.

3. The method of claim 1, further comprising:
receiving a second request for a second page associated with the first page; and
sending the second page to the client independent of accessing the database to retrieve the first subgroup of settings.

4. The method of claim 3, wherein receiving the second request comprises receiving the first subgroup of settings.

5. The method of claim 1, wherein the first subgroup of settings is sent to the client in a cookie.

6. The method of claim 5, wherein the cookie is a temporary cookie.

7. The method of claim 1, wherein the first subgroup of settings is disposed to be stored in cache memory at the client.

8. The method of claim 1, further comprising identifying the user.

9. The method of claim 8, wherein identifying the user comprises:
receiving sign-in information from the client.

10. The method of claim 8, wherein identifying the user comprises:
accessing a cookie at the client comprising user identification information.

11. A server system, comprising:
a web server; and
a database associated with the web server and comprising a group of settings associated with a user of a client, wherein the web server receives a first request for a first page from the client, retrieves from the database a first subgroup of settings from the group of settings, and sends the first subgroup of settings to the client, and
wherein the first subgroup of settings is smaller than the group of settings and is associated with the first page.

12. The system of claim 11, wherein the web server receives a second request for a second page and sends the second page to the client independent of retrieving from the database the first subgroup of settings.

13. The system of claim 11, wherein the first subgroup of settings is sent to the client in a cookie.

14. The system of claim 13, wherein the cookie is a temporary cookie.

15. The system of claim 11, wherein the first subgroup of settings is disposed to be stored in cache memory at the client.

16. A method, comprising:
storing product settings associated with a user and with a product in a group of settings, wherein the group of settings comprises settings associated with a user of a client;
receiving a first request for first information associated with the product from the client;
accessing the group of settings and retrieving a first subgroup of settings from the group of settings, wherein the first subgroup of settings is smaller than the group of settings; and
sending the first subgroup of settings to the client.

17. The method of claim 16, wherein the first subgroup of settings comprises the product settings.

18. The method of claim 16, further comprising:
receiving a second request for second information associated with the product from the client; and
sending the second information to the client independent of accessing the group of settings.

19. The method of claim 18, wherein receiving the second request comprises receiving the first subgroup of settings.

20. The method of claim 16, wherein the first subgroup of settings is sent to the client in a temporary cookie.
